(19) United States
(12) Patent Application Publication
(10) Pub. No.: US 2009/0167042 A1
(43) Pub. Date: Jul. 2, 2009

(54) Arm folding mechanism for use in a vehicle-mounted radiation imaging system

(76) Inventors: Zhiqiang Chen, Beijing (CN); Hua Peng, Beijing (CN); Shangmin Sun, Beijing (CN); Quanwei Song, Beijing (CN); Jinning Liang, Beijing (CN)

Correspondence Address: KENYON & KENYON LLP, ONE BROADWAY, NEW YORK, NY, 10004, US

(21) Appl. No.: 12/317,622

(22) Filed: Dec. 24, 2008

(30) Foreign Application Priority Data
Dec. 27, 2007 (CN) 200710304375.7

(51) Int. Cl. E05D 7/00; B60P 3/00

(52) U.S. Cl. 296/24.3; 16/221

(57) ABSTRACT

An arm-folding mechanism for use in a vehicle-mounted radiation imaging system. The vehicle includes a vehicle body behind a driving cab. The vehicle body includes a generator cabin and a control cabin. The arm-folding mechanism includes a vertical detection arm, a main arm frame, and a hinged mechanism hingedly connecting the vertical detection arm with the main arm frame. The hinged mechanism includes: a first connection arrangement having a free end and a fixed end fixedly connected with or integral with the main arm frame; a second connection arrangement fixedly connected with the vertical detection arm; and an intermediate arrangement connecting the first connection arrangement with the second connection arrangement so that the vertical detection arm can rotate relative to the main arm frame. The bottom of the first connection arrangement is at the same level as or above the bottom of the main arm frame.

### FIELD OF THE INVENTION

The present invention relates to the technical field of radiation detection, and more particularly, to an arm-folding mechanism for use in a vehicle-mounted radiation imaging system.

### BACKGROUND INFORMATION

Security inspection is of great significance in the fields of anti-terrorism and the fight against drug trafficking and smuggling, etc. People have been paying much more attention to security inspection on civil aviation since the U.S. Sep. 11, 2001 attacks. With the comprehensive development of the fight against drug trafficking and smuggling, the requirement for the inspection of air container and railway baggage etc. is much more stringent.

With reference to FIGS. 8, 9, 10, 11A, 11B and 11C, a vehicle-mounted imaging system previously used by the present applicants generally includes a vehicle carrying the imaging system and an arm-folding mechanism 44. The vehicle includes a vehicle body and a driving cab 42. The vehicle body is divided into a generator cabin 41 and a detection system control cabin 40 along the traveling direction of the vehicle. The arm-folding mechanism 44, when in a folded state, is compactly disposed on the top of the vehicle body as shown in FIG. 9 so as to be carried and transported by the vehicle to places in need. A vertical detection arm of the arm-folding mechanism 44 is positioned on an equipment room. There is no spatial requirement for the equipment room, so the equipment room can be provided very low such that the folded vertical detection arm can be placed on top of it. The folded vertical detection arm is usually located on the side face of the main arm frame of the arm-folding mechanism 44 and the lowest point of the vertical detection arm is lower than the lowest point of the main arm frame. A revolving bearing portion of the main arm frame is positioned above the generator cabin and extends slantways downwards from the main arm frame to be lower than the plane on which the highest point of the top of the generator cabin is, so the top of the generator cabin has to be made into a stepped shape, i.e., it has two parallel planes at different heights. Thus, in such a vehicle-mounted imaging system, the revolving point of the original arm-folding mechanism occupies some space of the cabin, and a relatively larger subsidiary arm frame occupies more space of the cabin. The manufacture and processing of such a generator cabin is complex so that the cost of production is high.

The generator cabin 41 is close to the driving cab 42. An accelerator is located at the position of a passage formed by the unfolded vertical detection arm and the main arm frame so as to carry out radiation imaging detection, so the control cabin 40 is close to the accelerator, resulting in a harmful influence of radiation to an operator. The generator cabin 41 is not a human-operating area, so the generator cabin 41 configured to have a low area has no other defects except the complexity in production. However, in order to achieve a certain radiation protection level, the design of the system consequentially makes the control cabin 40 in the status of detection closer to the accelerator so that the walls and top of the control cabin need more anti-radiation materials. Hence, the load of the vehicle-mounted system is increased, the adaptability of the vehicle-mounted system to the vehicle load limitation regulations of each country is reduced, and the cost of production is increased.

When the arm-folding mechanism is in use, the folded arm-folding mechanism firstly needs to be rotated, within a plane that is parallel to the ground surface, about 90° towards the vehicle body so that the arm-folding mechanism is substantially perpendicular to the traveling direction of the vehicle, and then the vertical detection arm is rotated downwards about 90° so that the vertical detection arm is substantially perpendicular to the main arm frame as well as the ground surface, as shown in FIG. 8. At this time, the arm-folding mechanism is unfolded, and the vertical detection arm is on one side of the vehicle and hung on the main arm frame by a hinged mechanism such that a detection passage area for allowing the passage of the objects to be detected is formed. The equipment room rotatably moves to the other side of the vehicle body, and the operator in the control cabin 40 makes corresponding control operation.

### SUMMARY OF THE INVENTION

Embodiments of the present invention provide an arm-folding mechanism usable in a vehicle-mounted radiation imaging system. Positions of a generator cabin and a control cabin are exchanged, thereby protecting the operator from radiation while reducing the use of the anti-radiation material. Meanwhile, the arm-folding mechanism is also advantageous in avoiding limiting the moving space of the operator caused by the occupation of some space to the cabin, so that the operator can comfortably work in the control cabin.

Additionally, it is known by those skilled in the art that the weight of the vehicle-mounted detection system is always an important index restricting its development, and a comparatively lighter vehicle weight and axle load will make it adaptable to requirements of regulations of more countries. The position of the generator cabin is exchanged with the position of the control cabin of the vehicle-mounted detection system by moving the control cabin forward such that the amount of anti-radiation material used in the control cabin is greatly reduced, and therefore, the weight of the control cabin is reduced. However, since the main arm frame occupies some space of the control cabin, a part of the top of the control cabin, after being moved forward, must sink downwards, which causes the moving space of the operator to be diminished and the difficulty in processing the cabin increased. This shortcoming is also overcome by the arm-folding mechanism of the present invention.

In the arm-folding mechanism of the present invention, the control cabin is positioned forward on the condition that the spatial dimension of the control cabin is unchanged, and a part of the top of the control cabin does not need to sink, which reduces the difficulty in processing the equipment room

Thus, an object of the present invention is to provide an improved arm-folding mechanism for use in a vehicle-mounted imaging system with regard to the aforesaid shortcomings in the prior art, the arm-folding mechanism allows a hinged portion of the main arm frame to be located on a higher plane on the top of the control cabin, such that the moving space for the operator is increased to provide a more comfortable environment for the operator. The cost and difficulty of processing the cabin is decreased because the arm-folding mechanism allows the control cabin to be exchanged with the generator cabin without diminishing the dimension of the control cabin such that the anti-radiation material used in the control cabin is greatly reduced and further the on-board weight is lightened.

It is another object of the present invention to provide a novel arm-folding mechanism that reduces the self weight of a conventional arm-folding mechanism.

It is a further object of the present invention to provide an improved arm-folding mechanism for use in a vehicle-mounted imaging system in order to realize the folding and unfolding of the vertical detection arm in a new manner and ensure the posture of the vertical detection arm when in the status of detection.

It is another object of the present invention to provide an vehicle-mounted imaging system having the arm-folding mechanism of the present invention, where, viewed from the traveling direction of the vehicle, the generator cabin is behind the control cabin which is close to the driving cab, and the top of the control cabin and the top of the generator cabin can be a single plane structure.

The above objects of the present invention are achieved by the technical solutions described below.

In an example embodiment of the present invention, an arm-folding mechanism for use in a vehicle-mounted radiation imaging system is provided. The vehicle includes a vehicle body behind a driving cab. The vehicle body includes a generator cabin and a control cabin. The arm-folding mechanism includes a vertical detection arm, a main arm frame, and a hinged mechanism hingedly connecting the vertical detection arm with the main arm frame. The hinged mechanism includes: a first connection arrangement having a free end and a fixed end fixedly connected with or integral with the main arm frame; a second connection arrangement fixedly connected with the vertical detection arm; and an intermediate arrangement connecting the first connection arrangement with the second connection arrangement so that the vertical detection arm can rotate relative to the main arm frame. The bottom of the first connection arrangement is at the same level as or above the bottom of the main arm frame.

In a preferred example embodiment, viewed from a working position, the first connection arrangement is close to a front side of the main arm frame.

In a preferred example embodiment, the intermediate arrangement includes a subsidiary arm frame and a revolving axle fixedly connected to each other.

In a preferred example embodiment, the subsidiary arm frame includes a fixed flange connected with the vertical detection arm and an axle sleeve fixedly connected with the revolving axle.

In a preferred example embodiment, at an end of the revolving axle of the subsidiary arm frame aligned with the fixed flange is provided a flange for securing the vertical detection arm and a bearing axle carrying the vertical detection arm and embedded in a hole of the end.

In a preferred example embodiment, the axle sleeve can be divided into upper and lower half axle sleeves detachably connected, the upper half axle sleeve being connected with or integral with the body of the subsidiary arm frame, a slot simultaneously being axially arranged on the outer diameter of the revolving axle and having the same length as the axial length of the axle sleeve such that the upper and lower half axle sleeves are embedded in the slot by a fastening arrangement.

In a preferred example embodiment, in a working status, the second connection arrangement is a protruding structure extending from the vertical detection arm to the main arm frame and beyond the width of the vertical detection arm, whereby the size of the detection passage is guaranteed.

An example embodiment of the present invention is directed to a vehicle-mounted radiation imaging system that uses the arm-folding mechanism of the present invention.

In a preferred example embodiment, the control cabin is adjacent to the driving cab, and the generator cabin is behind the control cabin.

In a preferred example embodiment, the top of the control cabin is a flat-top structure, and the space of the control cabin is suitable for operators to operate therein.

Some beneficial effects provided by the example embodiments of the present invention are as follows.
1. According to an example embodiment of the present invention, the positions of the control cabin and the generator cabin are exchanged as compared to a conventional system, without diminishing the spatial dimension of the control cabin, and the amount of the anti-radiation material of the control cabin body is greatly reduced so that the on-board weight is lightened.
2. According to an example embodiment of the present invention, the self weight of a preferred arm-folding mechanism of the present invention is greatly reduced compared with the prior art arm-folding mechanism. As shown in FIGS. 11A, 11B and 11C, especially 11C, the prior art arm-folding mechanism is huge in volume and connected with the vertical arm by two flanges 51, 52 and with the main arm frame by the revolving axle 53.
3. According to an example embodiment of the present invention, the top of the cabin does not need to sink any more, which simplifies the construction of the cabin of the prior art system.

### BRIEF DESCRIPTION OF THE DRAWINGS

FIG. 1 shows a first connection arrangement on a main arm frame in the hinged mechanism of an arm-folding mechanism, according to an example embodiment of the present invention.

FIG. 2 is an improved schematic view with respect to the first connection arrangement of FIG. 1, according to an example embodiment of the present invention.

FIG. 3 shows a working status of the arm-folding mechanism, according to an example embodiment of the present invention.

FIG. 4 shows a folded status of the arm-folding mechanism of FIG. 3, according to an example embodiment of the present invention.

FIG. 5 is a side view of a second connection arrangement on a vertical detection arm in the hinged mechanism of the arm-folding mechanism, according to an example embodiment of the present invention.

FIG. 6 is a frontal view of the second connection arrangement on the vertical detection arm in the hinged mechanism of the arm-folding mechanism, according to an example embodiment of the present invention.

FIG. 7A is a frontal view of the vehicle-mounted system in a status of storage and transportation, according to an example embodiment of the present invention.

FIG. 7B is a side view of the vehicle-mounted system in a status of storage and transportation, according to an example embodiment of the present invention.

FIG. 8, FIG. 9, and FIG. 10 are three dimensional views of the prior art arm-folding mechanism in a status of working and a status of folding as well as storage and transportation.

FIGS. 11A, 11B and 11C are, respectively, a side view, a frontal view, and a top view of the hinged mechanism of the prior art arm-folding mechanism.

### DETAILED DESCRIPTION

In order to describe the technical solution provided by the present invention more clearly and explicitly, the present invention will be described in detail with reference to the following preferred embodiments and the accompanying drawings.

“Front” and “back,” referred to hereinafter, are terms relative to a traveling direction of the vehicle. “Above” and “under” indicate relative positions in a height direction of the vehicle.

Additionally, in the present description, “left side of the vehicle body” and “right side of the vehicle body” are the left side and right side of a viewer when looking at the vehicle while standing in front of the head of the vehicle when in a stationary state.

FIG. 3 shows the arm-folding mechanism according to an example embodiment of the present invention when in an unfolded or in-use status, which includes a vertical detection arm 5, a main arm frame 1, and a hinging structure hingedly connecting the vertical detection arm 5 with the main arm frame 1, the hinging structure including a first connection arrangement connected with the main arm frame 1 and a second connection arrangement connected with the vertical detection arm 5, as well as an intermediate arrangement connecting the first connection arrangement with the second connection arrangement by relative rotation, where a body portion 2 of the first connection arrangement is parallel to a bottom horizontal plane 21 of the main arm frame 1 and at the same level as the bottom horizontal plane 21 or higher than the bottom horizontal plane 21.

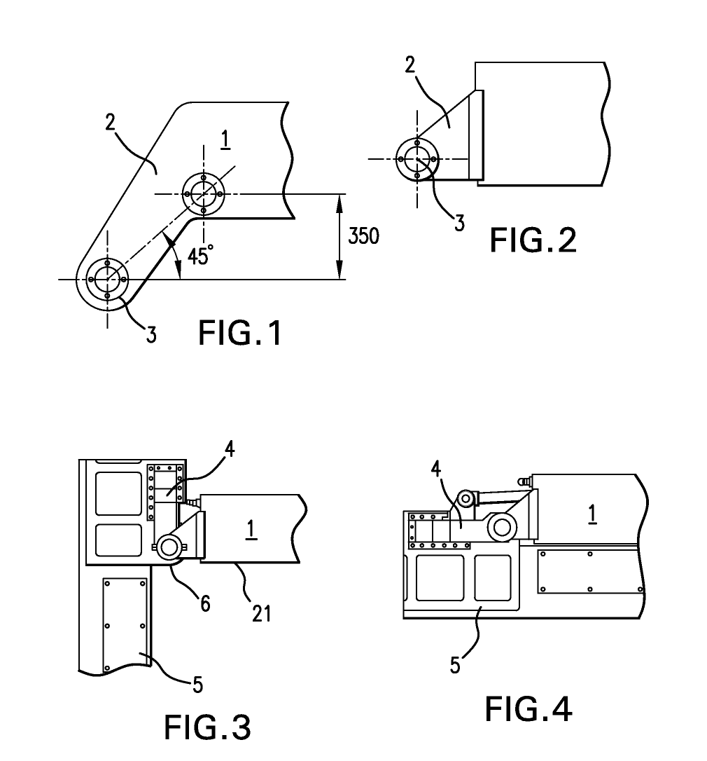

The improvement to the first connection arrangement over the prior art can be clearly seen from FIG. 1 and FIG. 2. In the prior art, the first connection arrangement and the main arm frame are integrally connected and extend slantways downwards, which causes the technical shortcoming of occupying some space of the control cabin. The first connection arrangement, according to an example embodiment of the present invention, includes a body portion 2 and a revolving bearing portion 3. However, other hinged arrangements can be used.

In FIG. 2, the body portion 2 of the first connection arrangement of the present invention is parallel to the main arm frame 1. The bottom of the first connection arrangement is preferably above the bottom of the main arm frame 1. The body portion 2 as shown in FIG. 2 is preferably a triangular plate-like element or other shapes that are good for reducing the amount of the materials used and the load of the vehicle. The body portion 2 can be seen more clearly in FIGS. 7A and 7B. On the frontal end of the main arm frame 1, the body portion 2 is as close as possible to the bottom of the main arm frame 1 and is connected to the main arm frame 1 close to one side of the main arm frame 1 (said side is a side of the main arm frame 1 facing forwardly in an unfolded state in the present embodiment), and the revolving bearing portion 3 is disposed on a hinged end of the body portion 2 (as shown in FIG. 2). As shown in FIG. 3 and FIG. 4, the second connection arrangement is preferably a vertical detection arm protruding structure 6 protruding from the top of the vertical detection arm 5 (in the working status) because the vertical detection arm protruding structure 6 can guarantee the size of the detection passage after the upward movement of the revolving hinged axle. The vertical detection arm protruding structure 6 can be connected with the vertical detection arm 5 in a conventional manner. For the purpose of reducing the weight of the second connection arrangement and the amount of the material used, the second connection arrangement, as shown in FIG. 3, can be a shape with the middle hollowed-out.

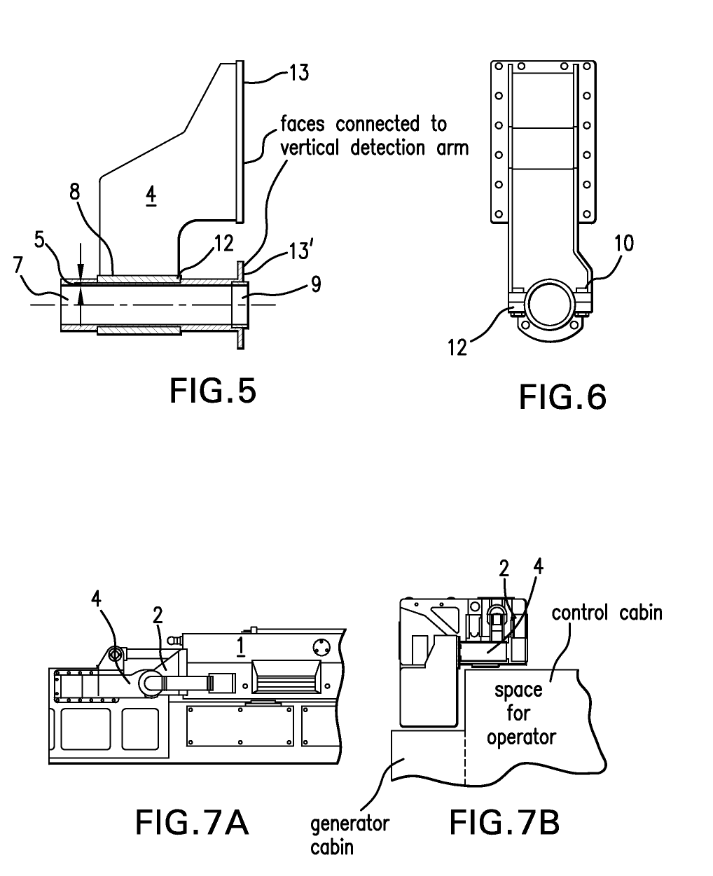

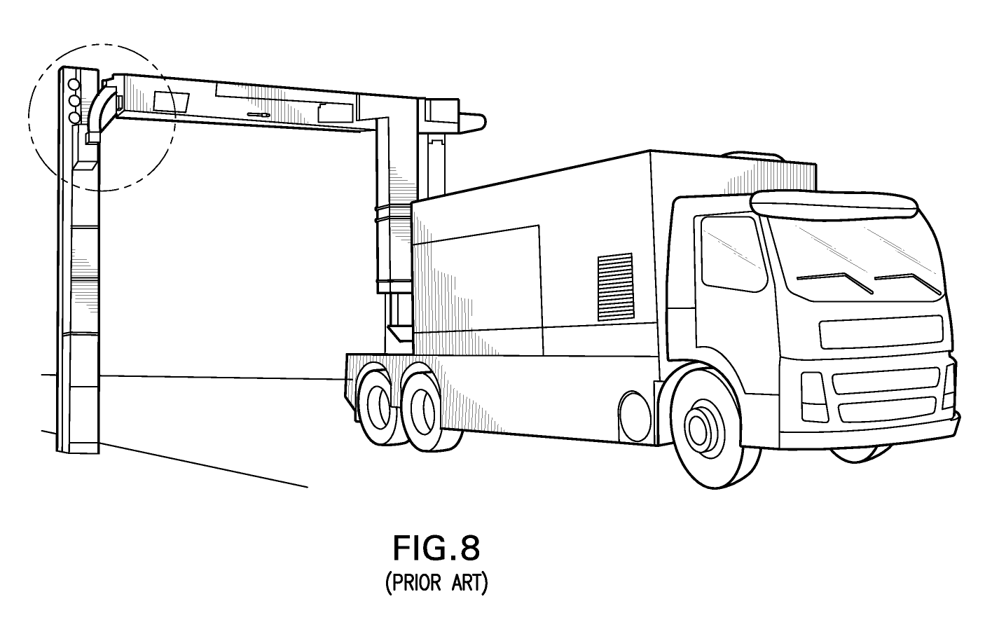

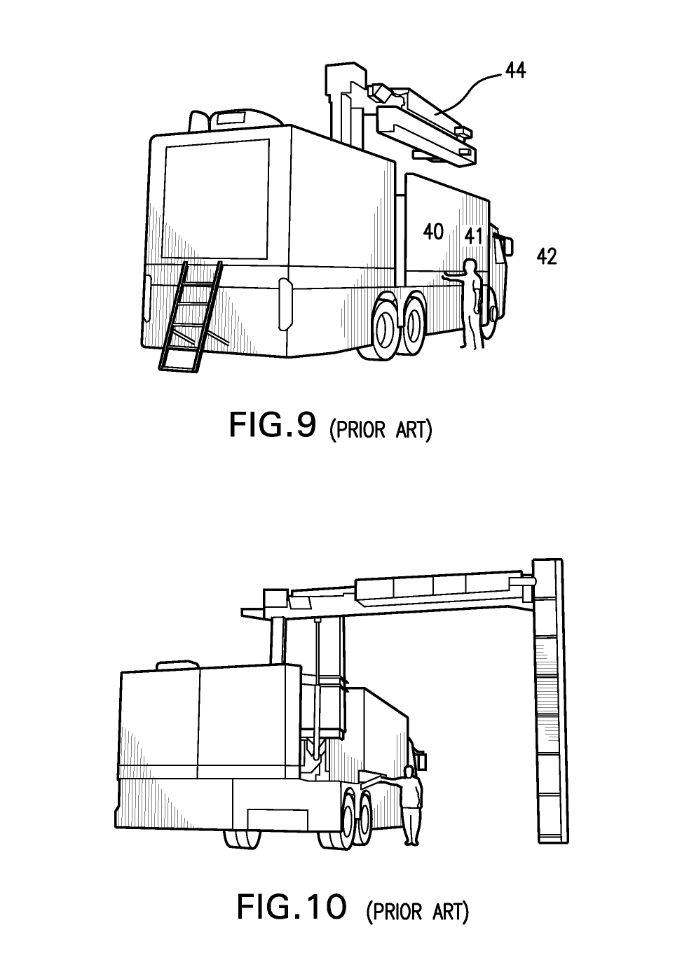

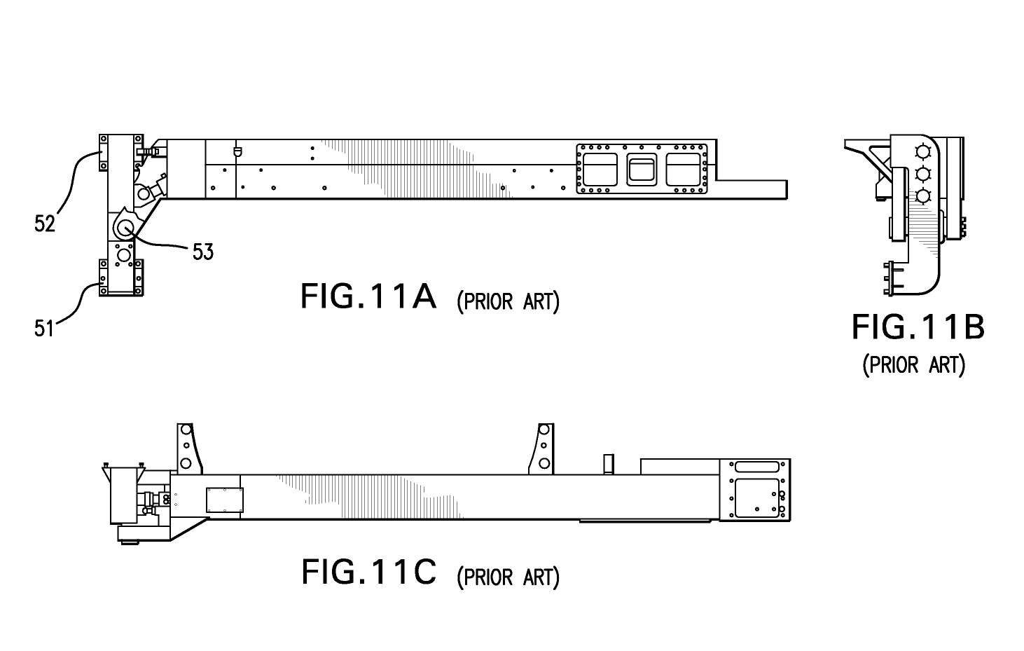

An intermediate arrangement as shown in FIG. 5 and FIG. 6 includes a subsidiary arm frame 4 and a revolving axle 7. The vertical detection arm protruding structure 6 can be connected integrally with the subsidiary arm frame 4 and the vertical detection arm 5 in any well-known manner as long as the protruding structure 6, the vertical detection arm 5 and the subsidiary arm frame 4 can be rotated integrally. The subsidiary arm frame 4 as shown in the drawings can be divided into a fixed flange 13 with a plurality of threaded holes, a transitional portion and an axle hole portion, these three portions being integral. The axle hole portion is divided into an upper half axle sleeve integral with the transitional portion and a lower half axle sleeve separable from the upper half axle sleeve for the ease of installation. On the outer diameter of the revolving axle 7 is preferably provided in an axial direction a slot 8 having a length the same as the axial length of the axle sleeve 12 of the subsidiary arm frame 4 such that the axle sleeve 12 can be embedded into the slot 8. The subsidiary arm frame 4 can be secured to the revolving axle 7 by a fastening device such as a bolt device 10 so as to prevent the subsidiary arm frame 4 from running on the revolving axle 7. As shown in FIG. 5, the revolving axle has a flange 13′ on the position substantially aligned with the flange 13 in order to strengthen its connection with the vertical detection arm. In addition, the revolving axle 7 can be hollow, with a bearing axle inserted into one end having the flange 13′ to further strengthen the bearing of the vertical detection arm 5. The hollow revolving axle 7 is connected with the revolving bearing 3 of the first connection arrangement so as to realize the rotational connection between the vertical detection arm 5 and the main arm frame 1. For the ease of transportation, the vertical detection arm 5 is rotated upwardly around the bearing 3 until being disposed in the position where the vertical detection arm 5 parallel overlaps with the main arm frame 1 and is as close as possible to the main arm frame 1.

As can be recognized in FIG. 4, the vertical detection arm 5 is controlled by a hydraulic cylinder so as to achieve automatic unfolding and remain a working status thereof.

In the vehicle-mounted radiation imaging system using this kind of arm-folding mechanism, the control cabin is preferably moved forward and adjacent to the driving cab.

Referring to FIGS. 7A and 7B, the following is a description to a folded status of the arm-folding mechanism, according to an example embodiment of the present invention. The vertical detection arm 5 is folded by an automatic control and located at the left side and underside of the main arm frame 1. Then the main arm frame 1 and the vertical detection arm 5 are rotated together towards the vehicle body until being located on top of the vehicle body and substantially parallel to the traveling direction. As shown in FIG. 7B, the lowest position of the portion including the main arm frame 1 and the first connection arrangement on the top of the control cabin is above the control cabin and parallel thereto. An equipment room is disposed at the position of the vertical detection arm 5 such that there is no particular requirement for space and comfortableness.

Those skilled in the art can appreciate from the foregoing description that the present invention may be implemented in a variety of forms, that the various embodiments may be implemented alone or in combination, and that the above described example embodiments are not used for limiting the present invention. Therefore, while the embodiments of the present invention have been described in connection with particular examples thereof, the true scope of the embodiments of the present invention should not be so limited since other modifications will become apparent to the skilled practitioner upon a study of the drawings, specification, and following claims. Many duplicate and alternative solutions will be apparent to those skilled in the art in light of the disclosed content of the present application and should fall within the protection scope of the present invention.

What is claimed is:

1. An arm-folding mechanism for use in a vehicle-mounted radiation imaging system, the arm-folding mechanism comprising:
a vertical detection arm;
a main arm frame; and
a hinged mechanism hingedly connecting the vertical detection arm with the main arm frame, the hinged mechanism including:
a first connection arrangement having a free end and a fixed end that is one of fixedly connected with and integral with the main arm frame;
a second connection arrangement fixedly connected with the vertical detection arm; and
an intermediate arrangement connecting the first connection arrangement with the second connection arrangement so that the vertical detection arm is rotatable relative to the main arm frame;
wherein a bottom of the first connection arrangement is one of at a same level as and above a bottom of the main arm frame.

2. The arm-folding mechanism according to claim 1, wherein, in a working position, the first connection arrangement is near to a front side of the main arm frame with respect to a traveling direction of the vehicle.

3. The arm-folding mechanism according to claim 2, wherein the intermediate arrangement includes a subsidiary arm frame and a revolving axle fixedly connected to each other.

4. The arm-folding mechanism according to claim 3, wherein the subsidiary arm frame includes a fixed flange connected with the vertical detection arm and an axle sleeve fixedly connected with the revolving axle.

5. The arm-folding mechanism according to claim 4, wherein, at one end of the revolving axle aligned with the fixed flange, is provided a flange that secures the vertical detection arm and a bearing axle that carries the vertical detection arm and that is embedded in a hole of the end.

6. The arm-folding mechanism according to claim 5, wherein:
the axle sleeve is divided into detachably connected upper half and lower half axle sleeves, the upper half axle sleeve being one of connected with and integral with a body of the subsidiary arm frame; and
a slot axially is arranged on an outer diameter of the revolving axle and having a length equal to an axial length of the axle sleeve, such that the upper and lower half axle sleeves are embedded in the slot by a fastening element.

7. The arm-folding mechanism according to claim 5, wherein, in the working position, the second connection arrangement is a protruding structure extending from the vertical detection arm to the main arm frame and beyond a width of the vertical detection arm, a detection passage being formed in the working position.

8. The arm-folding mechanism according to claim 4, wherein, in the working position, the second connection arrangement is a protruding structure extending from the vertical detection arm to the main arm frame and beyond a width of the vertical detection arm, a detection passage being formed in the working position.

9. The arm-folding mechanism according to claim 3, wherein, in the working position, the second connection arrangement is a protruding structure extending from the vertical detection arm to the main arm frame and beyond a width of the vertical detection arm, a detection passage being formed in the working position.

10. A vehicle-mounted radiation imaging system, comprising:
an arm-folding mechanism, the arm-folding mechanism comprising:
a vertical detection arm;
a main arm frame; and
a hinged mechanism hingedly connecting the vertical detection arm with the main arm frame, the hinged mechanism including:
a first connection arrangement having a free end and a fixed end that is one of fixedly connected with and integral with the main arm frame;
a second connection arrangement fixedly connected with the vertical detection arm; and
an intermediate arrangement connecting the first connection arrangement with the second connection arrangement so that the vertical detection arm is rotatable relative to the main arm frame;
wherein a bottom of the first connection arrangement is one of at a same level as and above a bottom of the main arm frame.

11. The vehicle-mounted radiation imaging system according to claim 10, wherein a control cabin is adjacent to a driving cab, and a generator cabin is behind the control cabin.

12. The vehicle-mounted radiation imaging system according to claim 11, wherein a top of the control cabin is a flat-top structure, and a space of the control cabin is suitable for operators to operate therein.

13. The vehicle-mounted radiation imaging system according to claim 11, wherein a top of the control cabin is a flat-top structure and is higher than a top of the generator cabin.
